(19) United States
(12) Patent Application Publication
(10) Pub. No.: US 2009/0058323 A1
(43) Pub. Date: Mar. 5, 2009

(54) Flyback LED drive circuit with constant current regulation

(76) Inventor: Ta-Yung Yang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,134

(22) Filed: Aug. 30, 2007

(51) Int. Cl. H05B 37/02

(52) U.S. Cl. 315/307

(57) ABSTRACT

A flyback LED drive circuit for the plurality of LEDs is provided. An inductive device is coupled to an input voltage. A power transistor is connected to the inductive device in series to control the switching current of the inductive device. The energy is stored into the inductive device when the power transistor is turned on. The stored energy is delivered to the plurality of LEDs via a flyback diode when the power transistor is turned off. A control circuit is utilized to detect the switching current of the inductive device for generating a switching signal to provide a constant current to the plurality of LEDs.

### BACKGROUND OF THE INVENTION

1. Field of the Invention

The present invention relates to a LED drive circuit, and more specifically relates to a control circuit for LED driver.

2. Description of Related Art

Various switching control circuit have been proposed to drive LED, such as “Switching LED driver” by Yang, U.S. Pat. No. 7,245,089. However, the drawback of this prior art is the drive circuit does not fit for a wide input voltage range. Another disadvantage of this prior art is the high ripple current at LED. The object of the present invention is to solve foregoing problems and achieve a high efficiency LED drive circuit. The size and the cost of the LED drive circuit can be reduced.

### SUMMARY OF THE INVENTION

A LED drive circuit for the LEDs is provided. It includes an inductive device coupled to an input voltage. A power transistor is connected to the inductive device in series to control a switching current of the inductive device. A flyback diode is coupled to the inductive device. A plurality of LEDs are connected to the inductive device through the flyback diode. A control circuit is coupled to detect the switching current of the inductive device for generating a switching signal to control the power transistor. The control circuit controls the LED current as a constant through controlling the switching current of the inductive device when the power transistor is turned on. The energy is stored into the inductive device when the power transistor is turned on. The stored energy is delivered to the LEDs via the flyback diode when the power transistor is turned off. A capacitor is connected to the LEDs in parallel to make a filter for the LED current.

It is to be understood that both the foregoing general descriptions and the following detailed descriptions are exemplary, and are intended to provide further explanation of the invention as claimed. Still further objects and advantages will become apparent from a consideration of the ensuing description and drawings.

### BRIEF DESCRIPTION OF THE DRAWINGS

The accompanying drawings are included to provide further understanding of the invention, and are incorporated into and constitute a part of this specification. The drawings illustrate embodiments of the invention and, together with the description, serve to explain the principles of the invention.

FIG. 1 shows a circuit diagram of a flyback LED drive circuit in accordance with the preferred embodiment of the present invention.

FIG. 2 shows various signal waveforms of the power converter and the control circuit according to the present invention.

FIG. 3 shows a circuit diagram of a preferred embodiment of the control circuit according to the present invention.

FIG. 4 shows a circuit diagram of a preferred embodiment of a voltage-waveform detector according to the present invention.

FIG. 5 shows a circuit diagram of a preferred embodiment of an oscillator according to the present invention.

FIG. 6 shows a circuit diagram of a preferred embodiment of a current-waveform detector according to the present invention.

FIG. 7 shows a circuit diagram of a preferred embodiment of an integrator according to the present invention.

FIG. 8 shows a circuit diagram of a preferred embodiment of a PWM circuit according to the present invention.

FIG. 9 shows a circuit diagram of a preferred embodiment of an adder according to the present invention.

### DESCRIPTION OF THE PREFERRED EMBODIMENTS

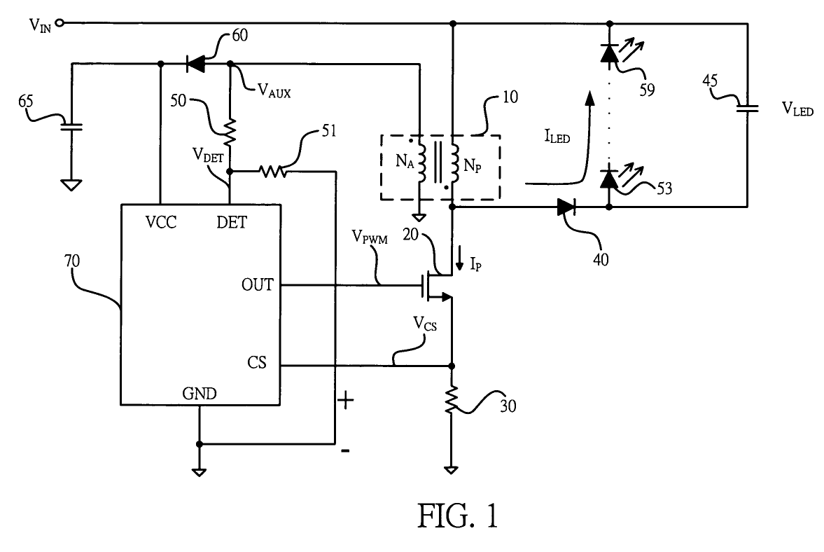

FIG. 1 shows a circuit diagram of a flyback LED drive circuit. It includes an inductive device 10 having an auxiliary winding N_{A} and a main winding N_{P}. The inductive device 10 serves as an inductor. The main winding N_{P} of the inductive device 10 is coupled to an input voltage V_{IN}. The main winding N_{P} provides an inductance L_{P} for producing a switching current I_{P}. The auxiliary winding N_{A} provides a power source to a control circuit 70. A power transistor 20 is connected to the inductive device 10 in series to control the switching current I_{P} of the inductive device 10. No switching current is flowed from the inductive device 10 to the LEDs 53 . . . 59 when the power transistor 20 is turned on. A flyback diode 40 is connected to the inductive device 10. The control circuit 70 is coupled to detect the switching current I_{P} of the inductive device 10 through a current-sense device, such as a resistor 30, for generating a switching signal V_{PWM} to control the power transistor 20.

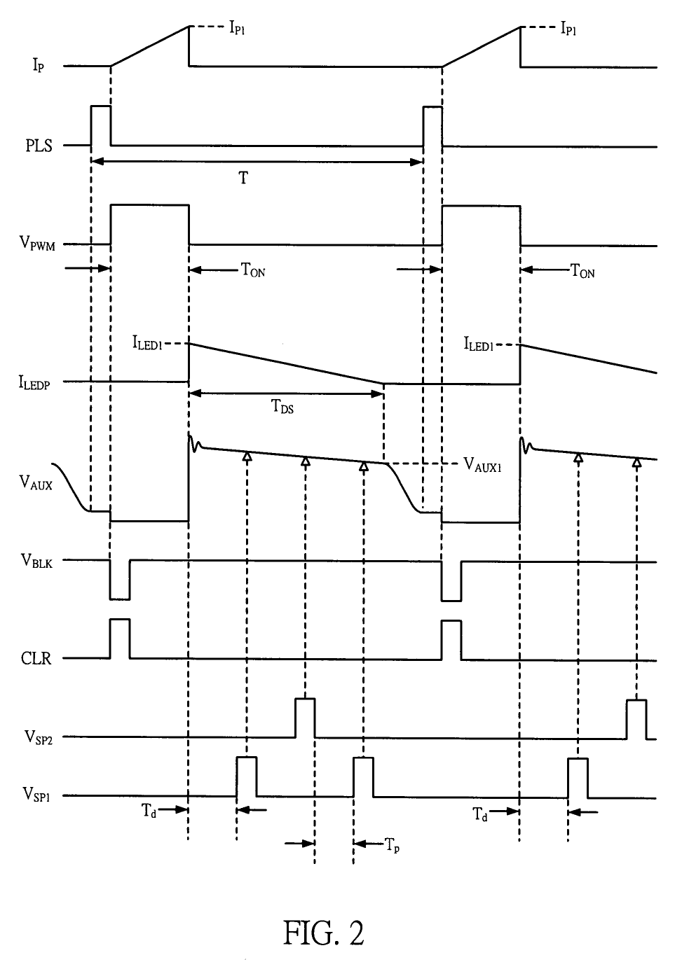

The LEDs 53 . . . 59 are connected in series and then connected to the inductive device 10 through the flyback diode 40. The switching current I_{P} of the inductive device 10 will flow to the flyback diode 40 and the LEDs 53 . . . 59 when the power transistor 20 is turned off. The control circuit 70 will detect and control the switching current I_{P} when the power transistor 20 is turned on and the switching current I_{P} of inductive device 10 is flowed through the power transistor 20. A capacitor 45 is further connected to the LEDs 53 . . . 59 in parallel to operate as a filter for the LED current I_{LED}. The control circuit 70 controls the LED current I_{LED} as a constant through controlling the switching current I_{P} of the inductive device 10 when the power transistor 20 is turned on. The control circuit 70 further detects a reflected voltage V_{AUX} of the inductive device 10 for regulating a maximum voltage V_{LED} across the LEDs 53 . . . 59. In order to control the maximum LED voltage V_{LED} and the LED current I_{LED}, the control circuit 70 generates the switching signal V_{PWM} to the power transistor 20 to switch the inductive device 10. FIG. 2 shows various signal waveforms of the LED drive circuit in FIG. 1. As the switching signal V_{PWM} is turned on, the switching current I will be generated accordingly. A peak value I_{P1} of the switching current I_{P} is given by,

$${I}_{P 1} = \frac{{V}_{IN}}{{L}_{P}} \times {T}_{ON} \qquad ( 1 )$$

where V_{IN} is the input voltage applied to the inductive device 10; L_{P} is the inductance of the main winding N_{P} of the inductive device 10; TON is an on-time of the switching signal V_{PWM}.

Once the switching signal V_{PWM} is turned off, the energy stored in the inductive device 10 will be delivered to the LEDs 53 . . . 59 via the flyback diode 40. A discharge LED current I_{LEDP} is generated accordingly. A peak value I_{LED1} of the discharge LED current I_{LEDP} is equal to a peak value I_{P1} of the switching current I_{P}. The discharge LED current I_{LEDP} can be expressed by,

$${I}_{LEDP} = \frac{( {V}_{LED} + {V}_{F} )}{{L}_{P}} \times {T}_{DS} \qquad ( 2 )$$

where V_{LED} is the LED voltage of the LEDs 53 . . . 59; V_{F} is a forward voltage drop of the flyback diode 40; T_{DS} is a discharge time (demagnetized time) of the inductive device 10.

Meanwhile, the reflected voltage V_{AUX} is generated at the auxiliary winding N_{A} of the inductive device 10. The reflected voltage V_{AUX} is given by,

$${V}_{AUX} = \frac{{T}_{NA}}{{T}_{NP}} \times ( {V}_{LED} + {V}_{F} ) \qquad ( 3 )$$

wherein T_{NP} and T_{NA} are the winding turns of the main winding N_{P} and the auxiliary winding N_{A} respectively.

The reflected voltage V_{AUX} starts to decrease as the discharge LED current I_{LEDP} falls to zero. This also indicates that the energy of the inductive device 10 is fully released at this moment. Therefore, as shown in FIG. 2, the discharge time T_{DS} in equation (2) can be measured from the falling edge of the switching signal V_{PWM} to the point that the reflected voltage V_{AUX} starts to fall.

Referring to FIG. 1, the control circuit 70 comprises a supply terminal VCC and a ground terminal GND for receiving power. A divider includes a resistor 50 and a resistor 51 connected between the auxiliary winding N_{A} of the inductive device 10 and the ground. A detection terminal DET of the control circuit 70 is connected to a joint of the resistor 50 and the resistor 51. A voltage V_{DET} generated at the detection terminal DET can be given by,

$${V}_{DET} = \frac{{R}_{51}}{{R}_{50} + {R}_{51}} \times {V}_{AUX} \qquad ( 4 )$$

where R₅₀ and R₅₁ are the resistance of the resistors 50 and 51.

The reflected voltage V_{AUX} further charges a capacitor 65 via a diode 60 to power the control circuit 70. The current-sense resistor 30 serves as a current-sense device. The current-sense resistor 30 is connected from the source of the power transistor 20 to the ground for converting the switching current I_{P} into a switching current signal V_{CS}. A sense terminal CS of the control circuit 70 is connected to the current-sense resistor 30 for detecting the switching current signal V_{CS}. An output terminal OUT of the control circuit 70 generates the switching signal V_{PWM} to switch the inductive device 10.

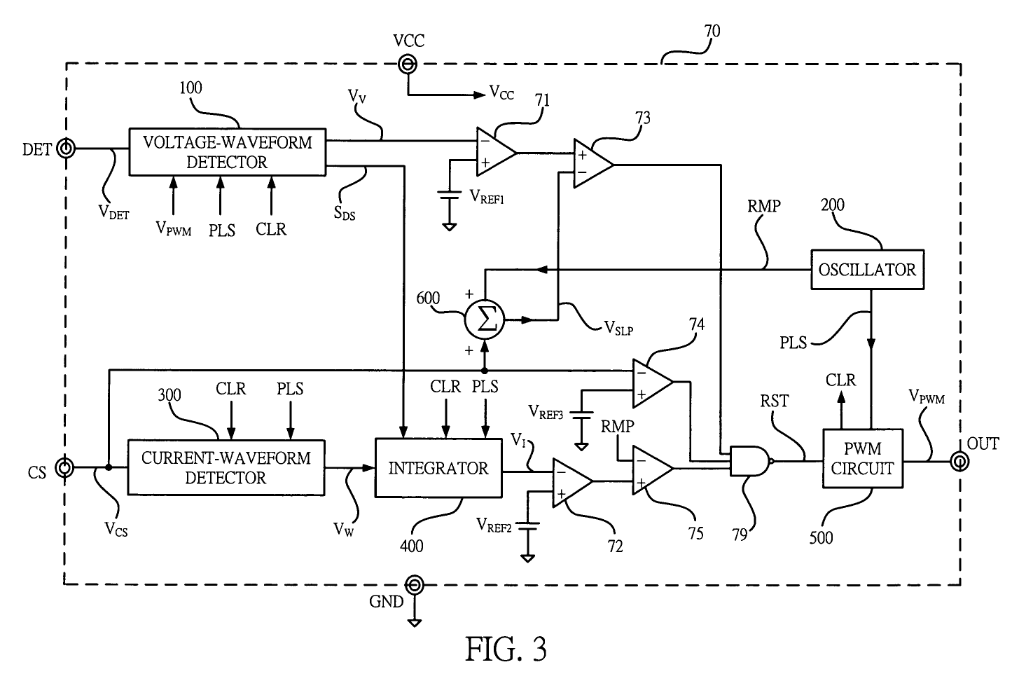

FIG. 3 shows a circuit diagram of a preferred embodiment of the control circuit 70. A voltage-waveform detector 100 coupled to the detection terminal DET produces a voltage-feedback signal V_{V} and a discharge-time signal S_{DS} by multi-sampling the voltage V_{DET}. It is to say, the voltage-waveform detector 100 measures the reflected voltage V_{AUX} (shown in FIG. 1). The discharge-time signal S_{DS} represents the discharge time T_{DS} of the discharge LED current I_{LEDP} (shown in FIG. 2). A current-waveform detector 300 coupled to the sense terminal CS generates a current-waveform signal V_{W} by measuring the switching current signal V_{CS}. An oscillator 200 generates an oscillation signal PLS for determining a switching frequency of the switching signal V_{PWM}. An integrator 400 coupled to the voltage-waveform detector 100 and the current-waveform detector 300 produces a current-feedback signal V_{I} by integrating the current-waveform signal V_{W} with the discharge-time signal S_{DS}. An operational amplifier 71 and a reference voltage V_{REF1} develop a voltage-loop error amplifier for amplifying the voltage-feedback signal V_{V} and providing a loop gain for output voltage control. A negative input terminal of the operational amplifier 71 is connected to the voltage-waveform detector 100 to receive the voltage-feedback signal V_{V}. A positive input terminal of the operational amplifier 71 is supplied with the reference voltage V_{REF1}. An operational amplifier 72 and a reference voltage V_{REF2} develop a current-loop error amplifier for amplifying the current-feedback signal V_{I} and providing a loop gain for output current control. A negative input terminal of the operational amplifier 72 is connected to the integrator 400 to receive the current-feedback signal V_{I}. A positive input terminal of the operational amplifier 72 is supplied with the reference voltage V_{REF2}.

A PWM circuit 500 and comparators 73 and 75 develop a switching control circuit to generate the switching signal V_{PWM} and control the pulse width of the switching signal V_{PWM} in response to the outputs of the voltage-loop error amplifier and the current-loop error amplifier. The PWM circuit 500 is connected to the output terminal OUT to output the switching signal V_{PWM}. The output of the operational amplifier 71 is connected to a positive input terminal of the comparator 73. The output of the operational amplifier 72 is connected to a positive input terminal of the comparator 75. A negative input terminal of the comparator 73 is connected to an output terminal of an adder 600. A negative input terminal of the comparator 75 is supplied with a ramp signal RMP that is produced from the oscillator 200.

The adder 600 generates a slope signal V_{SLP} by adding the switching current signal V_{CS} with the ramp signal RMP. A positive input terminal of a comparator 74 is supplied with a reference voltage V_{REF3}. A negative input terminal of the comparator 74 is connected to the sense terminal CS to receive the switching current signal V_{CS} for achieving a cycle-by-cycle current limit. Three input terminals of a NAND gate 79 are respectively connected to the output terminals of the comparators 73, 74 and 75. An output terminal of the NAND gate 79 generates a reset signal RST. The reset signal RST is supplied to the PWM circuit 500 for controlling the duty cycle of the switching signal V_{PWM}. The supply terminal VCC of the control circuit 70 provides a supply voltage V_{CC}.

A current control loop is formed from the detection of the switching current I_{P} to the pulse width modulation of the switching signal V_{PWM} to control the magnitude of the switching current I_{P} in response to the reference voltage V_{REF2}. According to the signal waveforms in FIG. 2, the LED current I_{LED} of the power converter is the average of the discharge LED current I_{LEDP}. The peak value I_{LED1} of the discharge LED current I_{LEDP} is equal to the peak value I_{P} of the switching current I_{P}. It can be expressed by,

$${I}_{LED} = {I}_{LED 1} \times \frac{{T}_{DS}}{2 T} \qquad ( 5 )$$

Therefore, the LED current I_{LED} is regulated. Where T is a switching period of the switching signal V_{PWM}.

The current-waveform detector 300 detects the switching current signal V_{CS} and generates the current-waveform signal V_{W}. The integrator 400 further produces the current-feedback signal V_{I} by integrating the current-waveform signal V_{W} with the discharge time T_{DS}. The current-feedback signal V_{I} is thus designed as,

$${V}_{1} = \frac{{V}_{W}}{2} \times \frac{{T}_{DS}}{{T}_{1}} \qquad ( 6 )$$

where the current-waveform signal V_{W} is expressed by,

V_{W}=R_{S}×I_{LED1} (7)

where T_{I} is a time constant of the integrator 400, the time constant T_{I} is correlated with the switching period T; R_{S} is the resistance of the resistor 30 (shown in FIG. 1). It can be seen from the equations (5)-(7), the current-feedback signal V_{I} can be rewritten as,

$${V}_{1} = \frac{T}{{T}_{1}} \times Rs \times {I}_{LED} \qquad ( 8 )$$

It can be found that the current-feedback signal V_{I} is proportional to the LED current I_{LED} of the power converter. The current-feedback signal V_{I} is increased as the LED current I_{LED} increases. However, the maximum value of the current-feedback signal V_{I} is limited to the value of the reference voltage V_{REF2} through the regulation of the current control loop. Under feedback control of the current control loop, a maximum LED current I_{LED}(max) is given by,

$${I}_{O ( max )} = \frac{{G}_{A} \times {G}_{SW} \times {V}_{REF 2}}{1 + ( {G}_{A} \times {G}_{SW} \times \frac{{R}_{S}}{K} )} \qquad ( 9 )$$

where K is a constant equal to T_{I}/T; G_{A} is the gain of the current-loop error amplifier; G_{SW} is the gain of the switching circuit.

As the loop gain of the current control loop is high (G_{A}×G_{SW}>>1), the maximum LED current I_{LED(max)} could be briefly defined as,

$${I}_{O ( max )} = K \times \frac{{V}_{REF 2}}{{R}_{S}} \qquad ( 10 )$$

The maximum LED current I_{LED(max)} of the power converter is thus regulated as a constant current in response to the reference voltage V_{REF2}. Besides, a voltage control loop is developed from the sampling of the reflected voltage V_{AUX} to the pulse width modulation of the switching signal V_{PWM}, which control the magnitude of the reflected voltage V_{AUX} in response to the reference voltage V_{REF1}. The reflected voltage V_{AUX} is a ratio of the maximum LED voltage V_{LED} as shown in equation (3). The reflected voltage V_{AUX} is further attenuated to the voltage V_{DET} as shown in equation (4). The voltage-waveform detector 100 generates the voltage-feedback signal V_{V} by multi-sampling the voltage V_{DET}. It is to say, the voltage-waveform detector 100 generates the voltage-feedback signal V_{V} by multi-sampling the reflected voltage V_{AUX}. The value of the voltage-feedback signal V_{V} is controlled in response to the value of the reference voltage V_{REF1} through the regulation of the voltage control loop. The voltage-loop error amplifier and the switching circuit provide the loop gain for the voltage control loop. Therefore the maximum LED voltage V_{LED} can be briefly defined as,

$${V}_{O} = ( \frac{{R}_{50} + {R}_{51}}{{R}_{50}} \times \frac{{T}_{NP}}{{T}_{NA}} \times {V}_{REF 1} ) - {V}_{F} \qquad ( 11 )$$

The reflected voltage V_{AUX} is multi-sampled by the voltage-waveform detector 100. The voltage is sampled and measured instantly before the discharge LED current I_{LEDP} falls to zero. Therefore the variation of the discharge LED current I_{LEDP} does not affect the value of the forward voltage drop V_{F} of the flyback diode 40.

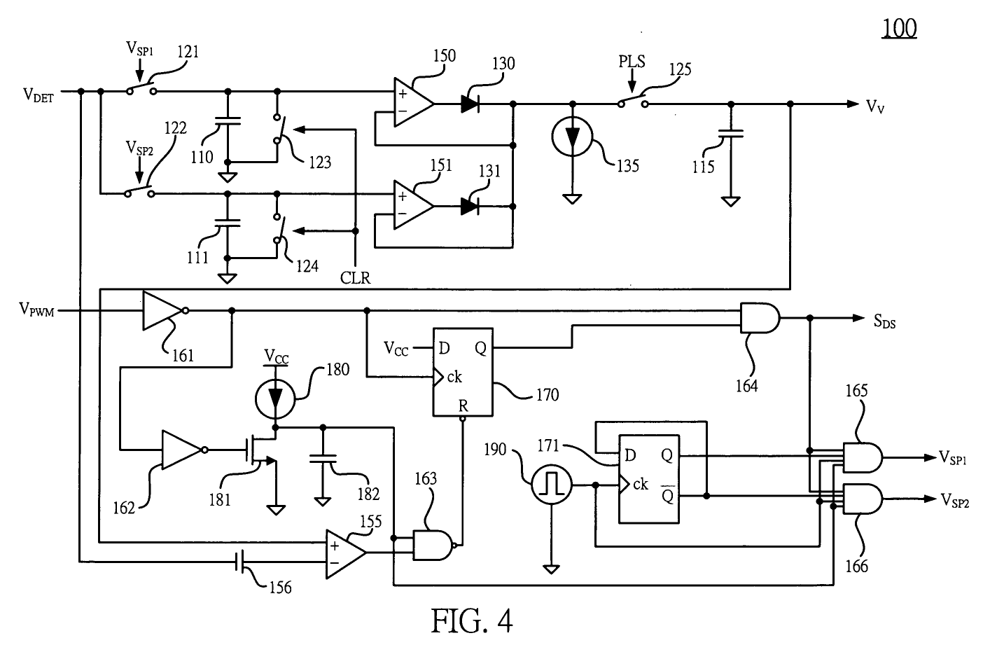

FIG. 4 shows a circuit diagram of a preferred embodiment of the voltage-waveform detector 100 according to the present invention. A sample-pulse generator 190 produces a sample-pulse signal for multi-sampling. A threshold voltage 156 is added up with the voltage V_{DET} to produce a level-shift reflected signal. It is to say, the level-shift reflected signal is produced by the threshold voltage 156 and the reflected voltage V_{AUX}. A first signal generator includes a D flip-flop 171, two AND gates 165, 166 for producing a first sample signal V_{SP1} and a second sample signal V_{SP2}. A second signal generator comprises a D flip-flop 170, an NAND gate 163, an AND gate 164 and a comparator 155 for producing the discharge-time signal S_{DS}. A time-delay circuit includes an inverter 162, a current source 180, a transistor 181 and a capacitor 182 for generating a delay time T_{d} (shown in FIG. 2) as the switching signal V_{PWM} is disabled.

An input terminal of an inverter 161 is supplied with the switching signal V_{PWM}. An output terminal of the inverter 161 is connected to an input terminal of the inverter 162, a first input terminal of the AND gate 164 and a clock-input terminal of the D flip-flop 170. An output terminal of the inverter 162 turns on/off the transistor 181. The capacitor 182 is connected in parallel with the transistor 181. The current source 180 is coupled to the supply voltage V_{CC} and the capacitor 182. The current source 180 is applied to charge the capacitor 182. Therefore the current of the current source 180 and the capacitance of the capacitor 182 determine the delay time T_{d} of the time-delay circuit. An output of the time-delay circuit is obtained across the capacitor 182.

A D-input terminal of the D flip-flop 170 is pulled high by the supply voltage V_{CC}. An output terminal of the D flip-flop 170 is connected to a second input terminal of the AND gate 164. The AND gate 164 outputs the discharge-time signal S_{DS}. The discharge-time signal S_{DS} is thus enabled as the switching signal V_{PWM} is disabled. The output terminal of the NAND gate 163 is connected to a reset-input terminal of the D flip-flop 170. Two input terminals of the NAND gate 163 are respectively connected to the output terminal of the time-delay circuit and an output terminal of the comparator 155. A negative input terminal of the comparator 155 is supplied with the level-shift reflected signal. A positive input terminal of the comparator 155 is supplied with the voltage-feedback signal V_{V}. Therefore, after the delay time T_{d}, the discharge-time signal S_{DS} can be disabled once the level-shift reflected signal is lower than the voltage-feedback signal V_{V}. Besides, the discharge-time signal S_{DS} can also be disabled as long as the switching signal V_{PWM} is enabled.

The sample-pulse signal is supplied to a clock-input terminal of the D flip-flop 171 and third input terminals of the AND gates 165 and 166. A D-input terminal and an inverse output terminal of the D flip-flop 171 are connected together to form a divided-by-two counter. An output terminal and the inverse output terminal of the D flip-flop 171 are respectively connected to second input terminals of the AND gates 165 and 166. First input terminals of the AND gates 165 and 166 are both supplied with the discharge-time signal S_{DS}. Fourth input terminals of the AND gates 165 and 166 are connected to the output terminal of the time-delay circuit. Therefore the first sample signal V_{SP1} and the second sample signal V_{SP2} are generated in response to the sample-pulse signal. Besides, the first sample signal V_{SP1} and the second sample signal V_{SP2} are alternately produced during an enabled period of the discharge-time signal S_{DS}. However, the delay time T_{d} is inserted at the beginning of the discharge-time signal S_{DS} to inhibit the first sample signal V_{SP1} and the second sample signal V_{SP2}. The first sample signal V_{SP1} and the second sample signal V_{SP2} are thus disabled during the period of the delay time T_{d}.

The first sample signal V_{SP1} and the second sample signal V_{SP2} are used for alternately sampling the reflected voltage V_{AUX} (shown in FIG. 1) via the detection terminal DET and the divider (shown in FIG. 1). The first sample signal V_{SP1} and the second sample signal V_{SP2} control a switch 121 and a switch 122 for obtaining a first hold voltage and a second hold voltage across a capacitor 110 and a capacitor 111 respectively. The switch 121 is connected between the voltage V_{DET} and the capacitor 110. The switch 122 is connected between the voltage V_{DET} and the capacitor 111. A switch 123 is connected in parallel with the capacitor 110 to discharge the capacitor 110. A switch 124 is connected in parallel with the capacitor 111 to discharge the capacitor 111. The switches 123 and 124 are turned on/off by a clear signal CLR that is generated from the PWM circuit 500 (shown in FIG. 3).

A buffer amplifier includes operational amplifiers 150 and 151, diodes 130, 131, and a current source 135 for generating a hold voltage. The positive input terminals of the operational amplifiers 150 and 151 are connected to the capacitor 110 and capacitor 111 respectively. The negative input terminals of the operational amplifiers 150 and 151 are connected to an output terminal of the buffer amplifier. The diode 130 is connected from an output terminal of the operational amplifier 150 to the output terminal of the buffer amplifier. The diode 131 is connected from an output terminal of the operational amplifier 151 to the output terminal of the buffer amplifier. The hold voltage is thus obtained from the higher voltage of the first hold voltage and the second hold voltage. The current source 135 is used for the termination. A switch 125 is connected between the output terminal of the buffer amplifier and a capacitor 115. The switch 125 periodically conducts the hold voltage to the capacitor 115 for producing the voltage-feedback signal V_{V}. The oscillation signal PLS turns on/off the switch 125. After the delay time T_{d}, the first sample signal V_{SP1} and the second sample signal V_{SP2} start to produce the first hold voltage and the second hold voltage. This eliminates the spike interference of the reflected voltage V_{AUX}. The spike interference of the reflected voltage V_{AUX} would occur when the switching signal V_{PWM} is disabled and the power transistor 20 is turned off.

As discharge LED current I_{LEDP} falls to zero, the reflected voltage V_{AUX} starts to decrease (shown in FIG. 2). This will be detected by the comparator 155 to disable the discharge-time signal S_{DS}. Therefore, the pulse width of the discharge-time signal S_{DS} can be correlated to the discharge time T_{DS} of discharge LED current I_{LEDP} (shown in FIG. 2). Meanwhile, the first sample signal V_{SP1} and the second sample signal V_{SP2} are disabled, and the multi-sampling is stopped as discharge-time signal S_{DS} is disabled. At the moment, the hold voltage generated at the output terminal of the buffer amplifier is thus correlated to the reflected voltage V_{AUX} that is sampled just during the discharge LED current I_{LEDP} falls to zero. The hold voltage is obtained from the higher voltage of the first hold voltage and the second hold voltage, which will ignore the voltage that is sampled when the reflected voltage had started to decrease.

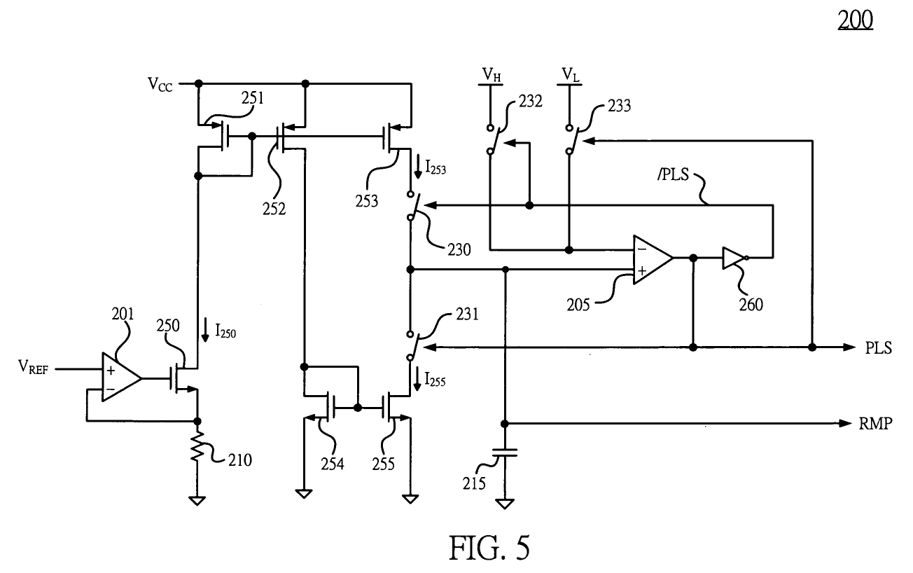

FIG. 5 shows a circuit diagram of a preferred embodiment of the oscillator 200 according to the present invention. An operational amplifier 201, a resistor 210 and a transistor 250 develop a first V-to-I converter. The first V-to-I converter generates a reference current I₂₅₀ in response to a reference voltage V_{REF}. A positive input terminal of the operational amplifier 201 is supplied with the reference voltage V_{REF}. A negative input terminal and an output terminal of the operational amplifier 201 are connected to the source and the gate of the transistor 250 respectively. The resistor 210 is connected between the source of the transistor 250 and the ground. The drain of the transistor 250 generates the reference current I₂₅₀.

A plurality of transistors, for example, transistors 251, 252, 253, 254 and 255 develop current mirrors for generating an oscillator charge current I₂₅₃ and an oscillator discharge current I₂₅₅ in response to the reference current I₂₅₀. The sources of the transistors 251, 252 and 253 are connected to the supply voltage V_{CC}. The gates of the transistors 251, 252, 253 and the drains of the transistors 251, 250 are connected together. The drain of the transistor 253 generates the oscillator charge current I₂₅₃. The sources of the transistors 254, 255 are connected to the ground. The gates of the transistors 254, 255 and the drains of the transistors 254, 252 are connected together. The drain of the transistor 255 generates the oscillator discharge current I₂₅₅. A switch 230 is connected between the drain of the transistor 253 and a capacitor 215. A switch 231 is connected between the drain of the transistor 255 and the capacitor 215. The ramp signal RMP is obtained across the capacitor 215. A comparator 205 has a positive input terminal connected to the capacitor 215. The comparator 205 outputs the oscillation signal PLS. As shown in FIG. 2, the oscillation signal PLS determines the switching frequency of the switching signal V_{PWM}. A first terminal of a switch 232 is supplied with a high threshold voltage V_{H}. A first terminal of a switch 233 is supplied a low threshold voltage V_{L}. A second terminal of the switch 232 and a second terminal of the switch 233 are both connected to a negative input terminal of the comparator 205. An input terminal of an inverter 260 is connected to an output terminal of the comparator 205 for producing the oscillation signal PLS. An output terminal of the inverter 260 generates an inverse oscillation signal /PLS. The oscillation signal PLS turns on/off the switch 231 and the switch 233. The inverse oscillation signal /PLS turns on/off the switch 230 and the switch 232. The resistance R₂₁₀ of the resistor 210 and the capacitance C₂₁₅ of the capacitor 215 determine the switching period T of the switching frequency,

$$T = \frac{{C}_{215} \times {V}_{OSC}}{{V}_{REF} / {R}_{210}} = {R}_{210} \times {C}_{215} \times \frac{{V}_{OSC}}{{V}_{REF}} \qquad ( 12 )$$

where V_{OSC}=V_{H}−V_{L}.

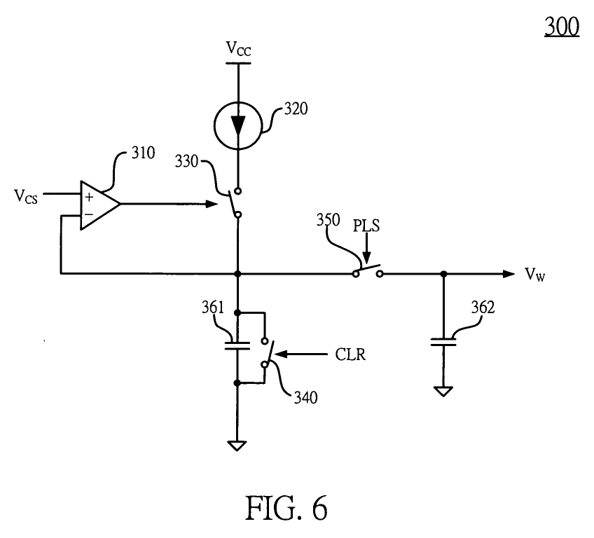

FIG. 6 shows a circuit diagram of a preferred embodiment of the current-waveform detector 300 according to the present invention. A peak detector includes a comparator 310, a current source 320, switches 330, 340, and a capacitor 361. The peak value of the switching current signal V_{CS} is sampled for generating a peak-current signal. A positive input terminal of the comparator 310 is supplied with the switching current signal V_{CS}. A negative input terminal of the comparator 310 is connected to the capacitor 361. The switch 330 is connected between the current source 320 and the capacitor 361. An output of the comparator 310 turns on/off the switch 330. The current source 320 is connected to the supply voltage V_{CC}. The switch 340 is connected in parallel with the capacitor 361 for discharging the capacitor 361. The switch 340 is turned on/off by the clear signal CLR that is generated from the PWM circuit 500 (shown in FIG. 3). A switch 350 is connected between the capacitor 361 and a capacitor 362. The switch 350 periodically conducts the peak-current signal to the capacitor 362 for producing the current-waveform signal V_{W}. The switch 350 is turned on/off by the oscillation signal PLS.

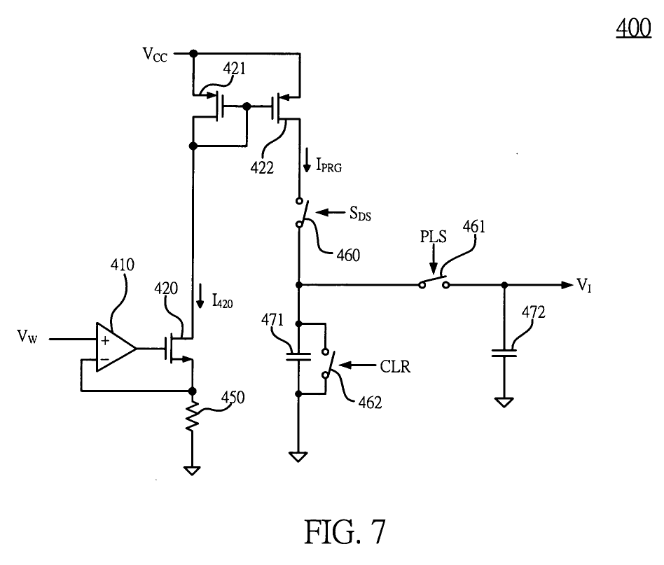

FIG. 7 shows a circuit diagram of a preferred embodiment of the integrator 400 according to the present invention. A second V-to-I converter comprises an operational amplifier 410, a resistor 450 and transistors 420, 421, 422. A positive input terminal of the operational amplifier 410 is supplied with the current-waveform signal V_{W}. A negative input terminal of the operational amplifier 410 is connected to the resistor 450. An output of the operational amplifier 410 drives the gate of the transistor 420. The source of the transistor 420 is coupled to the resistor 450. The second V-to-I converter generates a current I₄₂₀ via the drain of the transistor 420 in response to the current-waveform signal V_{W}. Transistors 421 and 422 form a current mirror having a 2:1 ratio. The current mirror is driven by the current I₄₂₀ to produce a programmable charge current I_{PRG} via a drain of the transistor 422. The sources of the transistors 421, 422 are connected to the supply voltage V_{CC}. The gates of the transistors 421, 422 and the drains of the transistors 421, 420 are connected together. The programmable charge current I_{PRG} can be expressed by,

$${I}_{PRG} = \frac{1}{{R}_{450}} \times \frac{{V}_{W}}{2} \qquad ( 13 )$$

where R₄₅₀ is the resistance of the resistor 450;

A capacitor 471 is used to produce an integrated signal. A switch 460 is connected between the drain of the transistor 422 and the capacitor 471. The switch 460 is turned on/off by the discharge-time signal S_{DS}. A switch 462 is connected in parallel with the capacitor 471 for discharging the capacitor 471. A switch 461 is connected between the capacitor 471 and a capacitor 472. The switch 461 periodically conducts the integrated signal to the capacitor 472 for producing the current-feedback signal V_{I}. The oscillation signal PLS turns on/off the switch 461. The current-feedback signal V_{I} is therefore obtained across the capacitor 472.

$${V}_{1} = \frac{1}{{R}_{450} \times {C}_{471}} \times \frac{{V}_{W}}{2} \times {T}_{DS} \qquad ( 14 )$$

According to the preferred embodiment in FIG. 4˜7, the current-feedback signal V_{I} is correlated to the LED current I_{LED}. Thus, the equation (8) can be rewritten as,

V_{I}=m×R_{S}×I_{LED} (15)

where m is a constant, which can be determined by,

$$m = \frac{{R}_{210} \times {C}_{215}}{{R}_{450} \times {C}_{471}} \times \frac{{V}_{OSC}}{{V}_{REF}} \qquad ( 16 )$$

The resistance R₄₅₀ of the resistor 450 is correlated to the resistance R₂₁₀ of the resistor 210 (shown in FIG. 5). The capacitance C₄₇₁ of the capacitor 471 is correlated to the capacitance C₂₁₅ of the capacitor 215 (shown in FIG. 5). Therefore, the current-feedback signal V_{I} is proportional to the LED current I_{LED} (shown in FIG. 1) of the power converter.

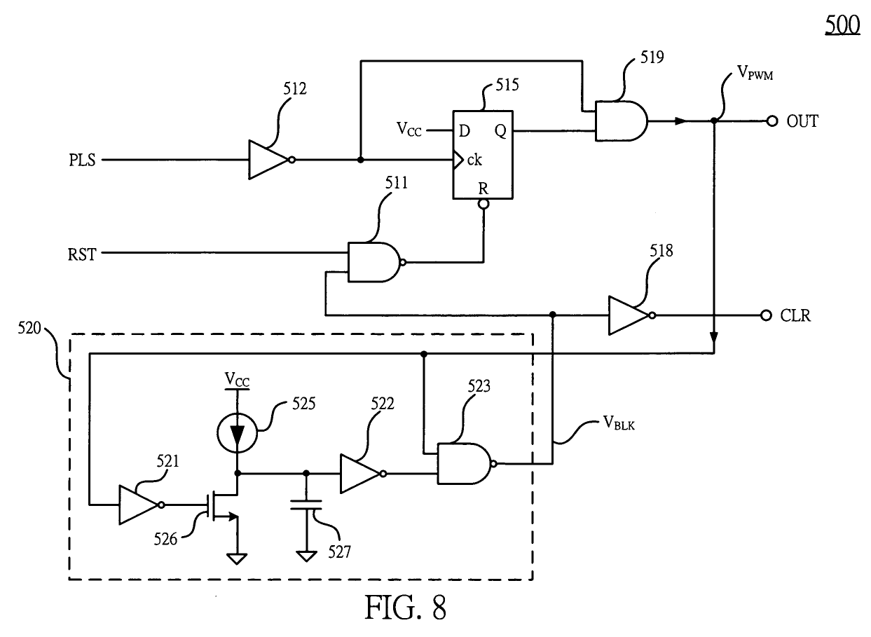

FIG. 8 shows a circuit diagram of the PWM circuit 500 according to the present invention. The PWM circuit 500 includes a NAND gate 511, a D flip-flop 515, an AND gate 519, a blanking circuit 520 and inverters 512, 518. A D-input terminal of the D flip-flop 515 is pulled high by the supply voltage V_{CC}. The oscillation signal PLS drives an input terminal of the inverter 512. An output terminal of the inverter 512 is connected to a clock-input terminal of the D flip-flop 515 for enabling the switching signal V_{PWM}. An output terminal of the D flip-flop 515 is connected to a first input terminal of the AND gate 519. A second input terminal of the AND gate 519 is coupled to the output terminal of the inverter 512. The AND gate 519 outputs the switching signal V_{PWM} to switch the inductive device 10 (shown in FIG. 1). A reset-input terminal of the D flip-flop 515 is connected to an output terminal of the NAND gate 511. A first input terminal of the NAND gate 511 is supplied with the reset signal RST for cycle-by-cycle disabling the switching signal V_{PWM}. The second input terminal of the NAND gate 511 is connected to an output terminal of the blanking circuit 520 for ensuring a minimum on-time of the switching signal V_{PWM} when the switching signal V_{PWM} is enabled.

An input terminal of the blanking circuit 520 is supplied with the switching signal V_{PWM}. As shown in FIG. 2, when the switching signal V_{PWM} is enabled, the blanking circuit 520 will generate a blanking signal V_{BLK} to inhibit the reset of the D flip-flop 515. The blanking circuit 520 further comprises an NAND gate 523, a current source 525, a capacitor 527, a transistor 526 and inverters 521, 522. The switching signal V_{PWM} is supplied to an input terminal of the inverter 521 and the first input terminal of the NAND gate 523. The current source 525 is connected to the supply voltage V_{CC}. The current source 525 is applied to charge the capacitor 527. The capacitor 527 is connected in parallel with the transistor 526. An output of the inverter 521 turns on/off the transistor 526. An input terminal of the inverter 522 is coupled to the capacitor 527. An output terminal of the inverter 522 is connected to a second input terminal of the NAND gate 523. An output terminal of the NAND gate 523 outputs the blanking signal V_{BLK}. The current of the current source 525 and the capacitance of the capacitor 527 determine the pulse width of the blanking signal V_{BLK}. An input terminal of the inverter 518 is connected to the output terminal of the NAND gate 523. An output terminal of the inverter 518 generates the clear signal CLR to turn on/off the switches 123, 124, 340 and 462 (shown in FIG. 4, 6, 7).

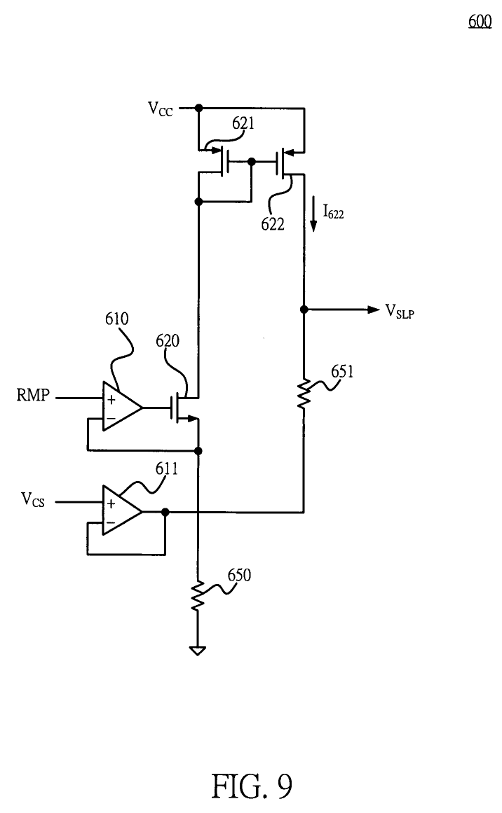

FIG. 9 shows a circuit diagram of the adder 600 according to the present invention. An operational amplifier 610, transistors 620, 621, 622 and a resistor 650 develop a third V-to-I converter for generating a current I₆₂₂ in response to the ramp signal RMP. A positive input terminal of the operational amplifier 610 is supplied with the ramp signal RMP. A negative input terminal and an output terminal of the operational amplifier 610 are connected to the source and the gate of the transistor 620 respectively. The resistor 650 is connected between the source of the transistor 620 and the ground. The sources of the transistors 621 and 622 are connected to the supply voltage V_{CC}. The gates of the transistors 621, 622 and the drains of the transistors 621, 620 are connected together. The drain of the transistor 622 generates the current I₆₂₂. A positive input terminal of an operational amplifier 611 is supplied with the switching current signal V_{CS}. A negative input terminal and an output terminal of the operational amplifier 611 are connected together to build the operational amplifier 611 as a buffer. The drain of the transistor 622 is connected to the output terminal of the operational amplifier 611 via a resistor 651. The slope signal V_{SLP} is generated at the drain of the transistor 622. The slope signal V_{SLP} is therefore correlated to the ramp signal RMP and the switching current signal V_{CS}.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A LED drive circuit, comprising:
an inductive device coupled to an input voltage;
a power transistor connected to the inductive device in series to control a switching current of the inductive device, the switching current being not flowed from the inductive device to a plurality of LEDs when the power transistor being turned on;
a flyback diode coupled to the inductive device; and
a control circuit coupled to detect the switching current of the inductive device for generating a switching signal to control the power transistor;
wherein the plurality of LEDs are connected to the flyback diode and connected to the inductive device through the flyback diode, the switching current of the inductive device will flow to the flyback diode and the plurality of LEDs when the power transistor is turned off, the control circuit will detect and control the switching current when the power transistor is turned on and the switching current of the inductive device is flowed through the power transistor.

2. The LED drive circuit as claimed in claim 1, further comprising a capacitor coupled to the plurality of LEDs in parallel.

3. The LED drive circuit as claimed in claim 1, wherein the control circuit controls a LED current of the plurality of LEDs as a constant through controlling the switching current of the inductive device when the power transistor is turned on.

4. The LED drive circuit as claimed in claim 1, wherein the inductive device has a main winding providing an inductance for producing the switching current, and the inductive device has an auxiliary winding providing a power source to the control circuit.

5. The LED drive circuit as claimed in claim 1, wherein the control circuit will detect a reflected voltage of the inductive device for regulating a maximum voltage across the plurality of LEDs.

6. The LED drive circuit as claimed in claim 1, wherein the control circuit, comprising:
a current-waveform detector generating a current-waveform signal by measuring the switching current of the inductive device;
an integrator producing a current-feedback signal by integrating the current-waveform signal in response to a discharge time of the inductive device;
a current-loop error amplifier amplifying the current-feedback signal; and
a switching control circuit generating the switching signal in response to an output of the current-loop error amplifier, wherein the switching signal is used for switching the inductive device and regulating a LED current.

7. The LED drive circuit as claimed in claim 6, wherein a time constant of the integrator is correlated with a switching period of the switching signal.

8. The LED drive circuit as claimed in claim 6, wherein the current-waveform detector comprises a peak detector for generating a peak-current signal by sampling a peak value of the switching current.

9. The LED drive circuit as claimed in claim 1, wherein the control circuit, comprising:
a voltage-waveform detector generating a voltage-feedback signal by measuring a reflected voltage of the inductive device;
a voltage-loop error amplifier amplifying the voltage-feedback signal; and
a switching control circuit generating the switching signal in response to an output of the voltage-loop error amplifier, wherein the switching signal is used for switching the inductive device and regulating a maximum LED voltage.

10. The LED drive circuit as claimed in claim 9, wherein the voltage-waveform detector multi-samples the reflected voltage to generate the voltage-feedback signal, wherein the voltage-feedback signal is obtained instantly when the inductive device is fully discharged.

11. A flyback LED drive circuit, comprising:
an inductor coupled to an input voltage;
a power transistor coupled to the inductor; and
a control circuit coupled to detect a switching current of the inductor for generating a switching signal to control the switching current and a current of a plurality of LEDs;
wherein the plurality of LEDs are connected to the inductor, the energy is stored into the inductor when the power transistor is turned on, the stored energy is delivered to the plurality of LEDs when the power transistor is turned off.

12. The flyback LED drive circuit as claimed in claim 11, further comprising a flyback diode coupled to the inductor and the plurality of LEDs.

13. The flyback LED drive circuit as claimed in claim 11, further comprising a capacitor coupled to the plurality of LEDs in parallel.

14. The flyback LED drive circuit as claimed in claim 11, wherein the control circuit controls the LED current as a constant through controlling the switching current of the inductor when the power transistor is turned on.

15. The flyback LED drive circuit as claimed in claim 11, wherein the inductor has an auxiliary winding for providing a power source to the control circuit.

16. The flyback LED drive circuit as claimed in claim 11, wherein the control circuit detects a reflected voltage of the inductor for regulating a maximum voltage across the plurality of LEDs.

17. The flyback LED drive circuit as claimed in claim 11, wherein the control circuit, comprising:
a current-waveform detector generating a current-waveform signal by measuring the switching current of the inductor;
an integrator producing a current-feedback signal by integrating the current-waveform signal in response to a demagnetized time of the inductor; and
a switching control circuit generating a switching signal in response to the current-feedback signal, wherein the switching signal is used for switching the inductor and regulating the LED current.

18. The flyback LED drive circuit as claimed in claim 17, wherein the current-waveform detector comprises a peak detector for generating a peak-current signal by sampling a peak value of the switching current.

19. The flyback LED drive circuit as claimed in claim 11, wherein the control circuit, comprising:
a voltage-waveform detector generating a voltage-feedback signal by measuring a reflected voltage of the inductor; and
a switching control circuit generating the switching signal in response to the voltage-feedback signal, wherein the switching signal is used for switching the inductor and regulating a maximum LED voltage.

20. The flyback LED drive circuit as claimed in claim 19, wherein the voltage-waveform detector multi-samples the reflected voltage to generate the voltage-feedback signal, wherein the voltage-feedback signal is obtained instantly when the inductor is fully discharged.
